(19) United States
(12) Patent Application Publication
(10) Pub. No.: US 2017/0253499 A1
(43) Pub. Date: Sep. 7, 2017

(54) METHOD AND APPARATUS FOR PRODUCING PURE WATER

(71) Applicant: KURITA WATER INDUSTRIES LTD., Tokyo (JP)

(72) Inventors: Takeo FUKUI, Tokyo (JP); Yoichi MIYAZAKI, Tokyo (JP)

(21) Appl. No.: 15/598,938

(22) Filed: May 18, 2017

Related U.S. Application Data
(63) Continuation of application No. 15/021,157, filed on Mar. 10, 2016.

(30) Foreign Application Priority Data
Nov. 11, 2013 (JP) 2013-233125

(51) Int. Cl. C02F 1/32; B01D 15/36

(52) U.S. Cl. CPC C02F 1/325; B01D 15/363; C02F 2001/422

(57) ABSTRACT

Provided are a method and an apparatus for producing pure water in which water that has been subjected to an ultraviolet oxidation treatment performed with an ultraviolet oxidation device is brought into contact with a platinum-group metal catalyst, the method and apparatus eliminating the likelihood of the catalyst being degraded and enabling decomposition of hydrogen peroxide to be performed for a prolonged period of time in a consistent manner. Water-to-be-treated is subjected to an ultraviolet oxidation treatment performed with an ultraviolet oxidation device and subsequently subjected to a hydrogen peroxide removal treatment performed with a hydrogen peroxide removal device including a platinum-group metal catalyst. The TOC concentration in water fed to the ultraviolet oxidation device is 5 ppb or less. An anion exchange resin tower is installed in a stage following the ultraviolet oxidation device.

### CROSS-REFERENCE TO RELATED APPLICATIONS

The present application is a continuation application of U.S. patent application Ser. No. 15/021,157, filed on Mar. 10, 2016 which was a National Phase of International Application No. PCT/JP2014/078912, filed on Oct. 30, 2014, which claims priority from Japanese Application No. 2013-233125, filed on Nov. 11, 2013, the disclosure of which is hereby incorporated by reference herein in its entirety.

### FIELD OF THE INVENTION

The present invention relates to a method and an apparatus for producing pure water and particularly relates to a method and an apparatus for producing pure water in which an ultraviolet oxidation device and a hydrogen peroxide removal device are used or included. The term “pure water” used herein also refers to ultrapure water.

### BACKGROUND OF THE INVENTION

In general, facilities for producing ultrapure water used for cleaning semiconductor and electronic materials include a pretreatment system, a primary pure water system, a subsystem, and the like. These systems each include devices that remove various impurities such as suspended materials, salts, and TOC.

FIG. 4 is a flow diagram illustrating an example of the ultrapure water production facility. As illustrated in FIG. 4, ultrapure water is produced by treating raw water (e.g., industrial water, city water, or well water) in an ultrapure water production facility including a pretreatment device 10, a primary pure water production device 11, and a secondary pure water production device (subsystem) 12.

The pretreatment device 10, which includes a coagulation unit, a dissolved-air-flotation (sedimentation) unit, a filtration (membrane filtration) unit, and the like, removes suspended solids and colloidal substances contained in the raw water. In this process, polymer organic substances, hydrophobic organic substances, and the like can also be removed.

The primary pure water production device 11, which includes a reverse osmosis membrane separation unit, a deaeration unit, and an ion-exchange unit (e.g., mixed-bed type or 4-bed 5-column type), removes ions and organic components contained in the raw water. The reverse osmosis membrane separation unit removes salts, ionic TOC, and colloidal TOC. The ion-exchange unit removes salts. In addition, TOC components are removed in the ion-exchange device by being adsorbed on an ion-exchange resin or through ion exchange. The deaeration unit removes inorganic carbon (IC) and dissolved oxygen.

In the subsystem 12, primary pure water produced with the primary pure water production device 11 is charged into a tank 14, passed into a heat exchanger 16 by using a pump 15, and subsequently treated with an ultraviolet (UV) irradiation device (in FIG. 4, low-pressure UV oxidation device) 17, an ion-exchange device 18, and an ultrafiltration (UF) membrane separation device 19 to produce ultrapure water. The low-pressure UV oxidation device 17 decomposes TOC into organic acids and, ultimately, into CO₂ by using UV with a wavelength of 185 nm which is emitted from a UV lamp. The organic substances and CO2 produced by the decomposition of TOC are removed in the subsequent ion-exchange device (normally, a mixed-bed ion-exchange device) 18. The UF membrane separation device 19 removes fine particles. The UF membrane separation device 19 also removes broken pieces and the like of the ion-exchange resin which may be discharged from the ion-exchange device 18.

Ultrapure water produced in the above-described manner is fed to a point-of-use 21 through a pipe 20. Excess ultrapure water is returned to the tank 14 through a pipe 22.

Through an oxidation treatment performed by irradiating water with ultraviolet radiation in the ultraviolet oxidation device 17, the organic substances (TOC components) contained in the water are decomposed into organic acids and carbonic acid. The oxidative decomposition of the TOC components in the ultraviolet oxidation device occurs because OH radicals produced by oxidative decomposition of water are used for oxidative decomposition of the TOC components. Therefore, the amount of ultraviolet radiation emitted from the ultraviolet oxidation device 17 of the subsystem 12 is set to be excessive such that oxidative decomposition of TOC contained in the water can be performed to a sufficient degree.

When the amount of ultraviolet radiation is large as described above, an excessive amount of OH radicals may be produced by the decomposition of water and excess OH radicals associate with one another to form hydrogen peroxide. When hydrogen peroxide produced in this step is brought into contact with an ion-exchange resin included in the subsequent mixed-bed ion-exchange device, not only does it become decomposed but it also deteriorates the ion-exchange resin. Furthermore, TOC components derived from the ion-exchange resin, which are produced due to the decomposition of the ion-exchange resin, may deteriorate the qualities of ultrapure water that is to be produced. In addition, part of hydrogen peroxide still remains in water that has been passed through the mixed-bed ion-exchange device. This may deteriorate the deaeration device and the UF membrane that are disposed downstream of the mixed-bed ion-exchange device.

Japanese Patent Publication 2007-185587 A (Japanese Patent 5124946 B) describes a method for removing hydrogen peroxide contained in ultrapure water, in which the concentration of hydrogen peroxide in water-to-be-treated is reduced to 1 ppb or less by bringing the water-to-be-treated containing hydrogen peroxide which is discharged from an ultraviolet oxidation device included in an ultrapure water production facility into contact with a hydrogen peroxide decomposition catalyst including an anion-exchange resin support and nanocolloidal platinum-group metal particles deposited on the support.

### CITATION LIST

### Patent Literature

Patent Literature 1: Japanese Patent Publication 2007-185587 A

### SUMMARY OF INVENTION

The inventor of the present invention conducted various studies and confirmed that, in the case where hydrogen peroxide-containing water discharged from the ultraviolet oxidation device is brought into contact with the platinum-group metal supporting catalyst in order to remove hydrogen peroxide from the water in accordance with PTL 1, the ability of the platinum-group metal supporting catalyst to decompose hydrogen peroxide starts decreasing at an early stage and hydrogen peroxide starts leaking into the treated water at an early stage when the concentration of organic acids in the hydrogen peroxide-containing water is high. In the case where the catalyst becomes degraded early as described above, the catalyst needs to be replaced at a high frequency in order to produce ultrapure water having high purity. This increases the cost of producing ultrapure water.

An object of the present invention is to address the above-described issues of the related art and to provide a method and apparatus for producing pure water in which water that has been subjected to an ultraviolet oxidation treatment performed with an ultraviolet oxidation device is brought into contact with a platinum-group metal catalyst, the method and apparatus eliminating (or reducing) the likelihood of the catalyst being degraded and enabling decomposition of hydrogen peroxide to be performed for a prolonged period of time in a consistent manner.

A method for producing pure water of the present invention is a method in which water-to-be-treated is subjected to an ultraviolet oxidation treatment performed with an ultraviolet oxidation device and subsequently subjected to a hydrogen peroxide removal treatment performed with a hydrogen peroxide removal device including a platinum-group metal catalyst, wherein the TOC concentration in water fed to the ultraviolet oxidation device is 5 ppb or less.

In the method for producing pure water of the present invention, the concentration of inorganic carbonate ions in the water fed to the ultraviolet oxidation device is preferably less than 1 ppb, and the concentration of inorganic carbonate ions in water that has been subjected to the ultraviolet oxidation treatment performed with the ultraviolet oxidation device is preferably 1 ppb or more.

In the method for producing pure water of the present invention, water that has been subjected to the ultraviolet oxidation treatment performed with the ultraviolet oxidation device is preferably subjected to an anion-exchange treatment and subsequently subjected to the hydrogen peroxide removal treatment performed with the hydrogen peroxide removal device.

An apparatus for producing pure water of the present invention includes an ultraviolet oxidation device; a hydrogen peroxide removal device including a platinum-group metal catalyst, the hydrogen peroxide removal device being disposed downstream of the ultraviolet oxidation device; and means for reducing the TOC concentration in water fed to the ultraviolet oxidation device to 5 ppb or less.

In the apparatus for producing pure water of the present invention, anion-exchange means is preferably interposed between the ultraviolet oxidation device and the hydrogen peroxide removal device.

### Advantageous Effects of Invention

TOC components contained in water-to-be-treated are oxidatively decomposed into organic acids and carbonic acid through an ultraviolet oxidation treatment performed with an ultraviolet oxidation device. In the present invention, the TOC concentration in water fed to the ultraviolet oxidation device is set to 5 ppb or less and is preferably set to 3 ppb or less. This reduces the concentration of organic acids in water discharged from the ultraviolet oxidation device and consequently reduces the likelihood of a platinum-group metal catalyst disposed downstream of the ultraviolet oxidation device for removing hydrogen peroxide being poisoned (degraded). As a result, the service life of the catalyst may be maintained long.

In the present invention, water discharged from the ultraviolet oxidation device is preferably subjected to an anion-exchange treatment in order to remove the organic acids and the carbonic acid. Removing the organic acids may further increase the service life of the platinum-group metal catalyst disposed downstream of the ultraviolet oxidation device.

In the present invention, in the case where the concentration of inorganic carbonate ions in water fed to the ultraviolet oxidation device is less than 1 ppb, the conditions under which the ultraviolet oxidation treatment is performed are changed such that the concentration of inorganic carbonate ions in the water fed to the ultraviolet oxidation device is 1 ppb or more. This increases the proportion of organic substances capable of being decomposed into CO₂ and consequently reduces the amount of hydrogen peroxide produced. As a result, the service life of the platinum-group metal catalyst may be increased.

### BRIEF DESCRIPTION OF DRAWINGS

FIG. 1 is a block diagram illustrating a method and an apparatus for producing pure water according to an embodiment.

FIG. 2 is a diagram used for explanation in Examples and Comparative Examples.

FIG. 3 is a diagram used for explanation in Examples and Comparative Examples.

FIG. 4 is a block diagram illustrating an ultrapure water production facility.

### DESCRIPTION OF EMBODIMENT

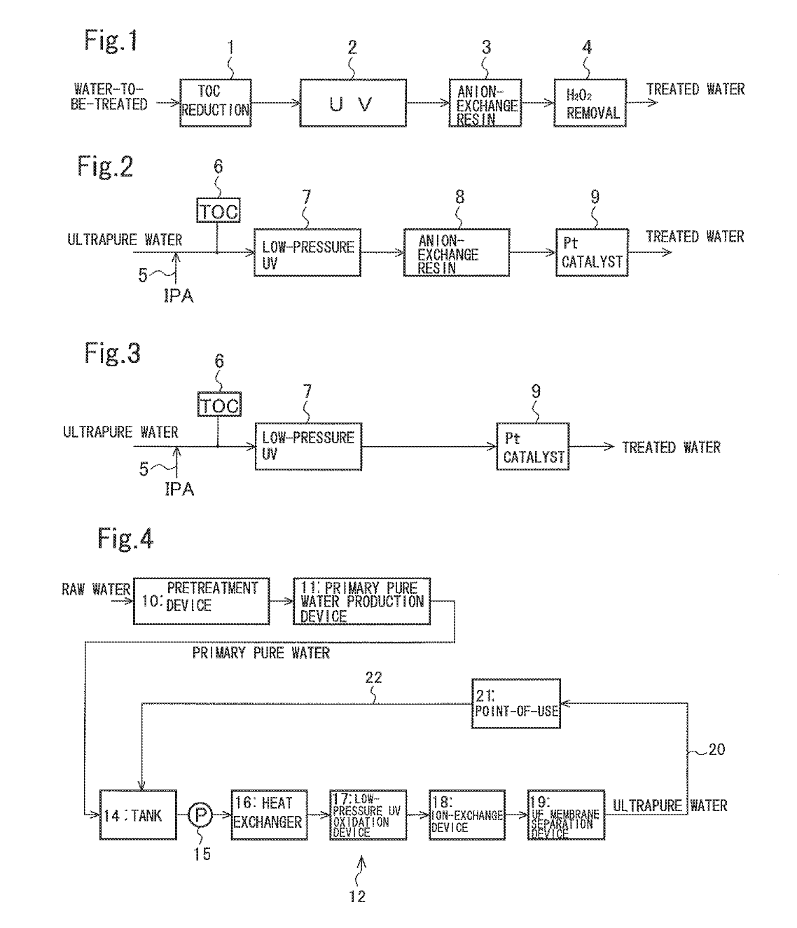

The present invention is further described in detail with reference to FIG. 1. In the embodiment illustrated in FIG. 1, water-to-be-treated is treated with an ultraviolet oxidation device 2 and subsequently subjected to a hydrogen peroxide removal treatment performed with a hydrogen peroxide removal device 4 including a platinum-group metal catalyst. The water-to-be-treated is preferably primary pure water produced with a primary pure water production device. In general, primary pure water produced with a primary pure water production device has the following qualities:

Electrical resistivity; 18 MΩ·cm or more

(Metal ion concentration: 5 ng/L or less, residual ion concentration: 10 ng/L or less)

Number of fine particles; fine particles having a size of 0.1 μm or more: 5 particle/mL or less

The concentration of inorganic carbonate ions in the water-to-be-treated such as primary pure water is preferably less than 1 ppb. In the case where the concentration of inorganic carbonate ions in the water-to-be-treated is 1 ppb or more, the concentration of the inorganic carbonates is preferably reduced to be less than 1 ppb by subjecting the water-to-be-treated to a decarbonation treatment, in which decarbonation devices such as a decarbonation column, an anion-exchange device, a vacuum deaeration device, and a deaeration membrane device are used alone or in combination of two or more.

In the case where the TOC concentration in the water-to-be-treated such as primary pure water is 5 ppb or less, the water-to-be-treated is directly fed to the ultraviolet oxidation device 2. In the case where the TOC concentration in the water-to-be-treated is more than 5 ppb, the TOC concentration is reduced to 5 ppb or less and is preferably reduced to 3 ppb or less by TOC reduction means 1. Examples of the TOC reduction means include a UV oxidation device, an ion-exchange device (commonly, an anion-exchange device), an organic substance adsorption device including active carbon or the like, and an advanced oxidation treatment device (UV oxidation +pro-oxidant such as H202 or persulfuric acid). In particular, a UV oxidation device and an ion-exchange device are preferable.

Through an ultraviolet oxidation treatment performed with the ultraviolet oxidation device 2, the TOC components are oxidatively decomposed into organic acids, carbonic acid, and hydrogen peroxide. In the present invention, the TOC concentration in water fed to the ultraviolet oxidation device 2 is set to 5 ppb or less and is preferably set to 3 ppb or less. This reduces the concentration of the organic acids in water discharged from the ultraviolet oxidation device 2 and consequently limits the likelihood of the platinum-group metal catalyst used for removing hydrogen peroxide, which is disposed downstream of the ultraviolet oxidation device 2, being poisoned. As a result, the service life of the catalyst may be maintained long.

In the present invention, in the case where the concentration of inorganic carbonate ions in water fed to the ultraviolet oxidation device 2 is less than 1 ppb, it is preferable to control conditions under which the ultraviolet oxidation device 2 is operated (e.g., input electric power and flow rate) such that the concentration of inorganic carbonate ions in water discharged from the ultraviolet oxidation device 2 is 1 ppb or more. This increases the proportion of organic substances capable of being decomposed into CO₂ and consequently reduces the amount of organic acids produced. As a result, the service life of the platinum-group metal catalyst may be increased. Note that, the reason for setting the concentration of inorganic carbonate ions in water fed to the ultraviolet oxidation device 2 to less than 1 ppb is to reduce the load put on the subsequent treatment.

The organic acids contained in water discharged from the ultraviolet oxidation device 2 are preferably removed by passing the water discharged from the ultraviolet oxidation device 2 through anion exchange means 3 in order to reduce the likelihood of the catalyst being poisoned by the organic acids. The anion exchange means is preferably an anion-exchange resin and is particularly preferably a strongly acidic anion-exchange resin. The anion-exchange resin may be mixed with a cation-exchange resin. This anion-exchange treatment removes the carbonic acid as well as the organic acids. The water is preferably passed through the anion-exchange resin at an SV of about 10 to 200 h⁻¹.

Water discharged from the anion exchange means 3 is passed through the hydrogen peroxide removal device 4 in order to remove hydrogen peroxide. The hydrogen peroxide removal device 4 includes a platinum-group metal catalyst. The platinum-group metal catalyst is preferably a catalyst including a support and colloidal platinum-group metal particles deposited on the support and is particularly preferably a catalyst including a support and nanocolloidal platinum-group metal particles deposited on the support.

Examples of the platinum-group metal include ruthenium, rhodium, palladium, osmium, iridium, and platinum. The above platinum-group metals may be used alone or in combination of two or more. Alternatively, an alloy of two or more metals selected from the above platinum-group metals may be used. In another case, a material produced by refining a naturally occurring mixture may be used without being separated into elements. Among these, platinum, palladium, and an alloy of platinum and palladium are particularly preferably used alone or in a mixture of two or more, because they have high catalytic activity.

A method for producing the nanocolloidal platinum-group metal particles is not limited. For example, a metal-salt reduction reaction method and a combustion method may be employed. Among the above methods, a metal-salt reduction reaction method may be suitably used, because it includes simple production steps and enables nanocolloidal metal particles having consistent qualities to be produced. In a metal-salt reduction reaction method, for example, 4 to 20 equivalent amount of a reductant such as an alcohol, citric acid, a salt of citric acid, formic acid, acetone, or acetaldehyde is added to an aqueous solution of a chloride, a nitrate, a sulfate, a metal complex, or the like of a platinum-group metal with a concentration of 0.1 to 0.4 mmol/L, and the resulting mixture is boiled for 1 to 3 hours to produce nanocolloidal platinum-group metal particles. In another case, a salt of a platinum-group metal, such as hexachloroplatinic acid or sodium hexachloroplatinate, is dissolved in an aqueous polyvinylpyrrolidone solution at a concentration of 1 to 2 mmol/L, a reductant such as ethanol is added to the resulting solution, and the solution is heated to reflux for 2 to 3 hours in a nitrogen atmosphere to produce nanocolloidal platinum-group metal particles.

The average diameter of the nanocolloidal platinum-group metal particles is preferably 1 to 50 nm, is more preferably 1.2 to 20 nm, and is further preferably 1.4 to 5 nm. The diameters of the nanocolloidal platinum-group metal particles are determined from an image captured with an electron microscope.

Examples of the support on which the nanocolloidal platinum-group metal particles are deposited include magnesia, titania, alumina, silica-alumina, zirconia, active carbon, zeolite, diatomaceous earth, and ion-exchange resins. Among the above supports, an anion-exchange resin is particularly suitably used. Since the nanocolloidal platinum-group metal particles include an electric double layer and are negatively charged, they are supported on an anion-exchange resin in a stable manner and less likely to detach from the anion-exchange resin. The nanocolloidal platinum-group metal particles supported on an anion-exchange resin have high catalytic activity in the decomposition and removal of hydrogen peroxide. The exchange group of the anion-exchange resin is preferably an OH-type exchange group. An OH-type anion-exchange resin has an alkaline surface, which promotes the decomposition of hydrogen peroxide.

The amount of nanocolloidal platinum-group metal particles supported on the anion-exchange resin is preferably 0.01% to 0.2% by weight and is more preferably 0.04% to 0.1% by weight.

When hydrogen peroxide-containing water is brought into contact with the hydrogen peroxide decomposition catalyst including a support and nanocolloidal platinum-group metal particles deposited on the support, hydrogen peroxide contained in the water is decomposed by the reaction 2H₂O₂→2H₂O+O₂. Although the method for bringing the hydrogen peroxide-containing water into contact with the hydrogen peroxide decomposition catalyst is not limited, it is preferable to pass the water through a hydrogen peroxide decomposition device filled with the hydrogen peroxide decomposition catalyst. Although the direction in which the water is passed through the hydrogen peroxide decomposition device may be upward or downward, the water is preferably passed through the hydrogen peroxide decomposition device downwardly in order to prevent the catalyst from flowing.

The flow rate at which the hydrogen peroxide-containing water is passed through a layer filled with the hydrogen peroxide removal catalyst is preferably such that a space velocity SV of 100 to 2,000 h⁻¹ is achieved and is more preferably such that a space velocity SV of 500 to 1,500 h¹ is achieved. Since the platinum-group metal catalyst markedly increases the rate of decomposition of hydrogen peroxide, hydrogen peroxide can be decomposed to a sufficient degree even when the water is passed through the layer at a space velocity SV of 100 h⁻¹ or more. However, if the water is passed through the layer at a space velocity SV of more than 2,000 h⁻¹, pressure drop that occurs while the water passes through the layer may become excessively large. In addition, hydrogen peroxide may fail to be decomposed and removed to a sufficient degree.

Since the nanocolloidal platinum-group metal particles supported on the anion-exchange resin have a large specific surface area, the rate of the decomposition reaction of hydrogen peroxide is considerably high. This makes it possible to increase the space velocity of the water that passes through the layer. Since the amount of water that passes through the layer is large compared with the amount of the catalyst used, the amount of the hydrogen peroxide decomposition catalyst used can be reduced. This reduces the treatment cost. Even in the case where the catalyst includes an anion-exchange resin and nanocolloidal platinum-group metal particles supported on the anion-exchange resin, hydrogen peroxide does not affect the anion-exchange resin because hydrogen peroxide is decomposed immediately upon coming into contact with the nanocolloidal platinum-group metal particles. Therefore, there is no risk that elution of organic carbon (TOC) occurs due to the anion-exchange resin being attacked by hydrogen peroxide.

The concentration of hydrogen peroxide in treated water that has been brought into contact with the hydrogen peroxide decomposition catalyst is preferably 5 ppb (weight ratio) or less and is more preferably 1 ppb (weight ratio) or less. When the concentration of hydrogen peroxide in the ultrapure water is 5 ppb (weight ratio) or less, the ultrapure water can be used for cleaning or the like without adversely affecting components of a semiconductor, a liquid crystal, or the like.

In the case where the present invention is applied to the ultrapure water production facility as illustrated in FIG. 4, it is preferable to interpose the anion-exchange resin column and the hydrogen peroxide removal device in series in this order between the low-pressure UV oxidation device 17 and the mixed-bed ion-exchange device 18.

### EXAMPLES

### Examples 1 to 3

Samples of synthetic primary pure water each prepared by adding IPA (isopropyl alcohol) to ultrapure water were treated in accordance with the flow illustrated in FIG. 2.

Specifically, IPA was in-line injected to ultrapure water in a consistent manner by using an IPA addition device 5 including a tank and a pump in order to prepare samples of IPA-containing synthetic primary pure water having TOC concentrations of 3, 5, and 10 ppb. The samples of IPA-containing synthetic primary pure water were each passed through a low-pressure ultraviolet oxidation device 7 (output: 0.6 kW, UV wavelength: 185 nm) at a flow rate of 10 L/min. Water discharged from the low-pressure ultraviolet oxidation device 7 was passed through a strongly acidic anion-exchange resin column 8 at an SV of 100 h⁻¹ and subsequently passed through a Pt-catalyst column 9 filled with an anion-exchange resin on which Pt particles were supported (produced by Nippon Sheet Glass Co., Ltd.; average diameter of nanocolloidal Pt particles: 10 nm) at an SV of 1000 h⁻¹. Table 1 summarizes the change with time in the concentration of hydrogen peroxide in the water discharged from the low-pressure ultraviolet oxidation device 7. Table 2 summarizes the change with time in the concentration of hydrogen peroxide in the water treated with the Pt-catalyst column 9.

### Examples 4 to 6

The same treatment as in Examples 1 to 3 was performed, except that the anion-exchange resin column 8 was omitted and water discharged from the low-pressure ultraviolet oxidation device 7 was directly passed through the Pt-catalyst column 9 as illustrated in FIG. 3. Table 3 summarizes the change with time in the concentration of hydrogen peroxide in the water treated with the Pt-catalyst column 9.

TABLE 1
H₂O₂ Concentration in UV-treated water (ppb)

| | Feed- | | | | | | |
|---|---|---|---|---|---|---|---|
| | water | | | | | | |
| Example | TOC | Elapsed days (Day) | | | | | |
| No. | (ppb) | 1 | 5 | 10 | 15 | 30 | 45 |
| 1 | 10 | 25 | 26 | 26 | 25 | 26 | 25 |
| 2 | 5 | 25 | 26 | 26 | 25 | 26 | 25 |
| 3 | 3 | 25 | 26 | 26 | 25 | 26 | 25 |

TABLE 2
H₂O₂ Concentration in water discharged
from Pt-catalyst column (ppb)

| | Feed- | | | | | | |
|---|---|---|---|---|---|---|---|
| | water | | | | | | |
| Example | TOC | Elapsed days (Day) | | | | | |
| No. | (ppb) | 1 | 5 | 10 | 15 | 30 | 45 |
| 1 | 10 | <1 | <1 | <1 | <1 | <1 | <1 |
| 2 | 5 | <1 | <1 | <1 | <1 | <1 | <1 |
| 3 | 3 | <1 | <1 | <1 | <1 | <1 | <1 |

(Anion-exchange treatment prior to contact with catalyst: Yes)

TABLE 3
H₂O₂ Concentration in water
discharged from Pt-catalyst column

| | Feed- | | | | | | |
|---|---|---|---|---|---|---|---|
| | water | | | | | | |
| Example | TOC | Elapsed days (Day) | | | | | |
| No. | (ppb) | 1 | 5 | 10 | 15 | 30 | 45 |
| 4 | 10 | <1 | <1 | <1 | 5 | 10 | 13 |
| 5 | 5 | <1 | <1 | <1 | <1 | <1 | 2 |
| 6 | 3 | <1 | <1 | <1 | <1 | <1 | <1 |

(Anion-exchange treatment prior to contact with catalyst: No)

As summarized in Table 1, the concentrations of hydrogen peroxide in the water discharged from the low-pressure ultraviolet oxidation device 7 were the same as one another in the cases where the TOC concentration in water fed to the low-pressure ultraviolet oxidation device 7 was set to 3, 5, and 10 ppb.

As summarized in Table 2, when water discharged from the low-pressure ultraviolet oxidation device 7 was brought into contact with the anion-exchange resin and subsequently passed through the Pt-catalyst column 9 as in the flow illustrated in FIG. 2, the ability of the catalyst to decompose hydrogen peroxide was maintained high for a long period of time even in the case where the TOC concentration in water at the entrance of the low-pressure ultraviolet oxidation device 7 was set to 10 ppb.

As summarized in Table 3, when water discharged from the ultraviolet oxidation device was directly passed through the Pt-catalyst column 9 as in the flow illustrated in FIG. 3, the ability of the catalyst to decompose hydrogen peroxide started decreasing 15 days after the start of passing water in the case where the TOC concentration in water at the entrance of the ultraviolet oxidation device was set to 10 ppb. The results confirm that, in the case where the concentration of hydrogen peroxide in the treated water needs to be less than 1 ppb, the hydrogen peroxide decomposition catalyst needs to be replaced once every few months even in consideration of the SV of actual machines being 1/10 the SV of this machine. In the case where ultrapure water having a TOC concentration of 5 ppb or less is to be produced, the performance of an actual machine may be ensured for 1 year or more without replacing the hydrogen peroxide decomposition catalyst.

The above results confirm that, while substances produced by the decomposition of TOC in the ultraviolet oxidation device reduce the ability of the platinum-group metal catalyst to decompose hydrogen peroxide, setting the TOC concentration in water fed to the ultraviolet oxidation device to 5 ppb or less and, preferably, removing the substances produced by the decomposition of TOC by using an anion-exchange resin disposed upstream of the hydrogen peroxide decomposition catalyst device markedly reduce the frequency at which the hydrogen peroxide decomposition catalyst including a platinum-group metal is replaced.

### Examples 7 to 10

For each of Examples 5 and 6, the amount of ultraviolet radiation emitted from the low-pressure ultraviolet oxidation device 7 was changed such that the concentration of inorganic carbonate ions in water (UV-treated water) discharged from the low-pressure ultraviolet oxidation device 7 was changed as described in Table 4. The results are described below together with the results of Examples 5 and 6.

TABLE 4

| | | Concentration | | Proportion | | | | | | |
|---|---|---|---|---|---|---|---|---|---|---|
| | | of | | of TOC | | | | | | |
| | | inorganic | | contained in | H₂O₂ Concentration | | | | | |
| | | carbonate | | feedwater | in water discharged | | | | | |
| | Feed- | ions (ppb) | | which was | from Pt-catalyst | | | | | |
| | water | | UV- | decomposed | column (ppb) | | | | | |
| | TOC | Feed- | treated | into HCO₃ | Elapsed days (Day) | | | | | |
| Example | (ppb) | water | water | (%) | 1 | 5 | 10 | 15 | 30 | 45 |
| 5 | 5 | <1 | 1 | 20 | <1 | <1 | <1 | <1 | <1 | 2 |
| 6 | 3 | <1 | 2 | 67 | <1 | <1 | <1 | <1 | <1 | <1 |
| 7 | 5 | <1 | 2 | 40 | <1 | <1 | <1 | <1 | <1 | <1 |
| 8 | 5 | <1 | <1 | <20 | <1 | <1 | <1 | <1 | <1 | 5 |
| 9 | 3 | <1 | 1 | 33 | <1 | <1 | <1 | <1 | <1 | <1 |
| 10 | 3 | <1 | <1 | <33 | <1 | <1 | <1 | <1 | <1 | 3 |

As summarized in Table 4, the higher the concentration of inorganic carbonate ions in water (UV-treated water) discharged from the low-pressure ultraviolet oxidation device 7, the longer the service life of the hydrogen peroxide decomposition catalyst. When the concentration of inorganic carbonate ions in the UV-treated water is 1 ppb or more and, in particular, 2 ppb or more, hydrogen peroxide is not detectable even after 45 days after the start of passing water.

Although the present invention has been described in detail with reference to a particular embodiment, it is apparent to a person skilled in the art that various modifications can be made therein without departing from the spirit and scope of the present invention.

The present application is based on Japanese Patent Application No. 2013-233125 filed on Nov. 11, 2013, which is incorporated herein by reference in its entirety.

### REFERENCE SIGNS LIST

1 TOC REDUCTION MEANS

2 ULTRAVIOLET OXIDATION DEVICE

3 ANION EXCHANGE MEANS

4 HYDROGEN PEROXIDE REMOVAL DEVICE

7 LOW-PRESSURE ULTRAVIOLET OXIDATION DEVICE

1. A method for producing ultrapure water using an ultrapure water production facility including, a primary pure water production device, and a secondary pure water production device whereby ultrapure water produced in the secondary pure water production device is fed to a point-of-use, excess ultrapure water from the point-of-use is returned and mixed with primary pure water from the primary pure water production device to produce mixed water, and the mixed water is treated as water-to-be-treated by the secondary pure water production device,
wherein in the secondary pure water production device, the water-to-be-treated is subjected to an ultraviolet oxidation treatment performed with an ultraviolet oxidation device and subsequently subjected to a hydrogen peroxide removal treatment performed with a hydrogen peroxide removal device including a platinum-group metal catalyst,
wherein the TOC concentration in water fed to the ultraviolet oxidation device is 5 ppb or less, and
wherein the concentration of inorganic carbonate ions in the water fed to the ultraviolet oxidation device is less than 1 ppb, and the concentration of inorganic carbonate ions in water that has been subjected to the ultraviolet oxidation treatment performed with the ultraviolet oxidation device is 1 ppb or more.

2. The method for producing ultrapure water according to claim 1, wherein water that has been subjected to the ultraviolet oxidation treatment performed with the ultraviolet oxidation device is subjected to an anion-exchange treatment and subsequently subjected to the hydrogen peroxide removal treatment performed with the hydrogen peroxide removal device.

3. An apparatus for producing ultrapure water comprising a primary pure water production device, and a secondary pure water production device whereby ultrapure water produced in the secondary pure water production device is fed to a point-of-use, excess ultrapure water from the point-of-use is returned and mixed with primary pure water from the primary pure water production device to produce mixed water, and the mixed water is treated as water-to-be-treated by the secondary pure water production device,
wherein the secondary pure water production device comprises an ultraviolet oxidation device; a hydrogen peroxide removal device including a platinum-group metal catalyst, the hydrogen peroxide removal device being disposed downstream of the ultraviolet oxidation device; and means for reducing the TOC concentration in water fed to the ultraviolet oxidation device to 5 ppb or less,
wherein the concentration of inorganic carbonate ions in water fed to the ultraviolet oxidation device is less than 1 ppb, and conditions under which the ultraviolet oxidation device is operated is controlled such that the concentration of inorganic carbonate ions in water discharged from the ultraviolet oxidation device is 1 ppb or more.

4. The apparatus for producing pure water according to claim 3, wherein anion-exchange means is interposed between the ultraviolet oxidation device and the hydrogen peroxide removal device.
